(19) United States
(12) Patent Application Publication
(10) Pub. No.: US 2007/0000127 A1
(43) Pub. Date: Jan. 4, 2007

(54) Cable with a central conductor of aluminum

(76) Inventors: Christian-Eric Bruzek, Thun St Martin (FR); Christophe Brismalein, Lievin (FR); Pascal Carpentier, Sinceny (FR)

Correspondence Address: SOFER & HAROUN LLP., 317 MADISON AVENUE, SUITE 910, NEW YORK, NY, 10017, US

(21) Appl. No.: 11/407,394

(22) Filed: Apr. 19, 2006

(30) Foreign Application Priority Data
Apr. 25, 2005 (FR) 05 51055

(51) Int. Cl. H01R 4/18

(52) U.S. Cl. 29/868; 174/106 R; 174/94 R; 29/857; 29/854

(57) ABSTRACT

A method of fabricating a cable and the cable obtained by implementing the method. The cable comprises a central conductor of aluminum covered in a layer of copper, said method improving the mechanical characteristics of the cable, in particular in terms of elongation and bending, and increasing its lifetime. According to the invention, the method consists in interposing an intermediate layer of nickel, niobium, tantalum, or vanadium between the central conductor and the copper layer. The invention is applicable in particular in the aviation industry.

### RELATED APPLICATION

This application is relate to and claims the benefit of priority from French Patent Application No. 05 51055, filed on Apr. 25, 2005, the entirety of which is incorporated herein by reference.

### FIELD OF THE INVENTION

The present invention relates to a method of fabricating a cable made up of an assembly of substantially identical wires, the central conductor of each wire being made of a aluminum. The invention also provides a cable as obtained by implementing the method. The cable is advantageous for use in the field of aviation and presents a lifetime and mechanical characteristics that are improved compared with prior art cables.

### BACKGROUND OF THE INVENTION

Mainly for reasons of saving weight, cables having a central conductor made of copper, a metal which is a very good conductor of electricity, are often replaced by cables in which the central conductor is made of aluminum that is covered in a layer of copper, with the copper layer constituting about 15% of the diameter of the cable while the aluminum thus occupies about 85% of the diameter of the cable.

Conventional techniques for making a copper-covered aluminum central conductor include the technique of continuous cold welding aluminum wire rods covered in copper strip (the technique known as the “Kabelmetal” method) and the cold hydrostatic press technique. In order to avoid the copper oxidizing while the cable is being insulated, a fine layer of nickel that is about one micrometer thick is conventionally deposited on the layer of copper. Nevertheless, aluminum cables present drawbacks both mechanically and electrically.

A first difficulty comes from the fact that after high temperature aging of a copper-covered aluminum cable, its mechanical properties are not as good as those of a conductor comprising aluminum only or copper only, in particular they are not as good as in terms of capability for elongation and for bending. The loss of elongation and bending capability has been observed by the present inventors on copper-covered aluminum cables, in particular after the final operations of fabrication and of high temperature aging over a long duration.

A second difficulty comes from the shortening in the lifetime of the aluminum central conductor that results from deterioration in its electrical properties. It has been observed that the electrical resistivity of the cable increases over time, and can rise to values that are not acceptable. A similar phenomenon is described in U.S. Pat. No. 5,704,993 for cables having a central conductor (not made of aluminum) that is covered in a metal layer. In a first embodiment, the central conductor was made of carbon steel and the metal layer was made of copper, nickel, silver, or gold. In a second embodiment, the central conductor was made of copper and the metal layer was made of carbon steel. A fine layer of niobium, vanadium, or tantalum was interposed between the central conductor and the metal layer. The fine layer serves as a diffusion barrier preventing copper from diffusing into the carbon steel. Nevertheless, it is stated in that US patent that an attempt at making a conductor made up of aluminum and carbon steel failed.

Patent application WO 94/13866 A relates to a method of fabricating an electric cable made up of an aluminum central core, an underlayer of copper, and a layer of tin. The object is to improve the solderability of the aluminum wire when using tin alloy solders.

U.S. Pat. No. 2,075,332 relates in general manner to apparatus for electrolytically depositing a layer of metal on a metal wire. That patent does not relate to aluminum conductors.

U.S. Pat. No. 3,867,265 describes a method of electrolytically depositing a layer of nickel, copper, tin, zinc, or cadmium on an aluminum or an aluminum-based conductor. However that document does not mention depositing an intermediate layer.

None of the above-mentioned documents describes a cable structure as proposed by the present invention.

### OBJECTS AND SUMMARY OF THE INVENTION

The present invention proposes remedying the two drawbacks of degraded mechanical properties and of diminished lifetime for a cable made up as an assembly of wires each having a central conductor made of aluminum covered in a layer of copper.

More precisely, the present invention proposes a method of fabricating a cable made up of an assembly of wires, each wire comprising a central conductor of aluminum covered in a layer of copper, said method improving the mechanical characteristics of the cable, in particular concerning elongation and bending, and also increasing its lifetime. The method consists in interposing an intermediate metal layer of nickel, niobium, tantalum, or vanadium between the central conductor and the copper layer.

In order to avoid the copper oxidizing while the cable is being insulated, a fine layer of nickel having a thickness of about one micrometer is usually deposited on the copper layer.

The techniques used for fabricating the conductor may be the following: the electroplating technique; the technique of continuously covering or welding with a strip or a tube; the technique of cold or hot extrusion or of using a hydrostatic press to apply a strip or a tube; or the technique of hot isostatic compression. It is also possible to use two of the above-mentioned techniques for making the wires: one technique being used for depositing the intermediate metal layer and the other technique being used for depositing the copper layer. It is also possible to use the same technique for depositing both layers.

The section of the intermediate metal layer of nickel, niobium, tantalum, or vanadium advantageously lies in the range 0.01% to 5% of the total section of the wire. This upper limit of 5% is not a technical limit but rather an economic limit, increased thickness leading to increased manufacturing cost.

The section of the copper layer of each wire advantageously lies in the range 10% to 30% of the total section of the wire.

In a preferred implementation, a wire rod constituting the conductor is cold-drawn or wire-drawn in order to obtain said cable.

An additional layer of nickel is advantageously deposited on the copper layer in order to prevent the copper from oxidizing.

### DETAILED DESCRIPTION OF THE INVENTION

Other advantages and characteristics of the invention appear from the following description of various implementations of the invention given as non-limiting examples.

In the conventional methods of the prior art, an aluminum cable is fabricated in a first method from substantially identical wire rods of aluminum covered in two copper strips, the assembly being continuously welded to form copper-covered aluminum wires. The metallic bonding between the copper and the aluminum is provided by subjecting the assembly to rolling and to wire-drawing. In another method, a copper-covered aluminum bar is obtained from a copper tube surrounding an aluminum bar. Section is reduced in a hydraulic press, thereby providing good metallic bonding between the copper and the aluminum. The resulting copper-covered aluminum wires are then annealed for about 2 hours at 200° C., and then assembled together to form a cable, which cable is insulated by means of a sheath of insulating plastics material such as polytetrafluoroethylene (PTFE), and is heated to about 370° C. for about 10 minutes. The inventors have observed that the mechanical characteristics of the copper-covered aluminum are degraded, particularly in terms of bending and elongation in traction. In prior-art cables, breaking elongation after insulation is about 3%. Breaking elongation is defined as the percentage elongation in traction to which the cable can be subjected without breaking. In the invention, with a fine intermediate metal layer of nickel, niobium, tantalum, or vanadium interposed between the aluminum and the copper, this degradation does not occur, or occurs in attenuated form. Under such circumstances, the inventors have obtained elongation values of more than 8%, capable of going up to more than 10%. The cable is thus better at withstanding traction and bending, and as a result its lifetime is increased.

The fabrication method of the invention can be implemented in various ways.

In one implementation, an aluminum cable is fabricated from an aluminum wire covered in nickel by continuous electroplating and then covered in copper by continuous electroplating. An anti-oxidation layer of nickel is electroplated on the copper layer. The wire is then subjected to wire-drawing in order to obtain a wire having a diameter that is close to 0.2 millimeters (mm), for example.

In another implementation, the starting material is a cylindrical bar of aluminum, e.g. having a diameter lying in the range about 40 mm to 60 mm, and a length lying in the range 1 meter (m) to 5 m. A layer of nickel, e.g. having a thickness of about 20 micrometers (μm) is deposited on the cylindrical surface of the aluminum bar, preferably by electrolytic nickel plating, as opposed to chemical nickel plating where the rate at which nickel is deposited is slower. The aluminum bar as nickel plated in this way is placed in a copper tube having the same length as the aluminum bar, with the inside diameter of the tube being very slightly greater than the diameter of the aluminum bar. The thickness of the copper tube is advantageously selected so that the section of the copper constitutes about 15% of the section of the aluminum. In the above example of an aluminum bar having a diameter of about 40 mm, the thickness of the copper tube is about 1.6 mm.

The assembly constituted by the nickel-plated aluminum bar surrounded by the copper tube is then cold-drawn, with intermediate anneals, so as to obtain an outside diameter for the copper tube of about 8 mm, and it is then wire-drawn and annealed to obtain a diameter of about 1.8 mm. Thereafter a nickel layer is deposited on the copper so as to prevent it oxidizing. Thereafter, the diameter of 1.8 mm is reduced down to about 0.2 mm by wire-drawing.

In another implementation of the method, niobium replaces nickel between the aluminum and the copper. Niobium sheets, e.g. having thickness lying in the range 25 μm to 400 μm is used to cover the aluminum bar so as to envelop it completely, the bar having a diameter of 50 mm and a length of 1 μm to 5 μm, for example. The sheets may be welded to the aluminum bar. As above, a copper tube is placed around the aluminum bar surrounded by niobium and is then subjected to cold-drawing. The assembly is then wire-drawn down to a diameter of 1.8 mm. An anti-oxidation layer of nickel is deposited by being electroplated on the drawn-down copper tube. Wire-drawing is then performed in order to obtain a wire having a diameter close to 0.2 mm.

In another implementation, the drawing operation is replaced by an operation of extruding the assembly formed by the aluminum bar surrounded by the intermediate layer of nickel, niobium, tantalum, or vanadium, and placed in a copper tube. By way of example, the diameter of the aluminum bar may be 500 mm, the thickness of the intermediate layer may be 0.6 mm, and the copper tube may have a thickness of 20 mm. Extrusion produces a wire having a diameter of about 8 mm which is reduced to an intermediate diameter in order to deposit a fine layer of nickel by electroplating, followed by wire-drawing down to a diameter of about 0.2 mm. The extrusion can take place cold, in a plurality of successive operations, but under such circumstances, the die must be capable of operating at very high pressures. It is therefore often preferable to perform extrusion hot and in a single operation, thus making it possible to work using lower extrusion pressures.

The cable formed in this way by cabling an assembly of wires is insulated using a sheath of plastics material and is heated to about 370° C. for 10 minutes. Elongation and bending measurements performed after those operations have revealed an improvement compared with identical cables made of copper-covered aluminum but without an intermediate layer of nickel, niobium, tantalum, or vanadium. As mentioned above, elongation values of more than 8% have been obtained for aluminum cables fabricated in accordance with the present invention, as compared with values of about 3% for conventional cables without the intermediate layer.

In addition to the advantages of conserving its elongation and bending characteristics, a cable made of aluminum covered in niobium, nickel, tantalum, or vanadium also presents electrical characteristics after high temperature aging, and in particular conductivity, that are improved. The fine intermediate layer acts as a diffusion barrier that prevents the copper diffusing into the aluminum and also prevents the aluminum from diffusing into the copper. This avoids forming a layer of copper mixed with aluminum situated between the aluminum conductor and the copper layer. It is this mixed aluminum/copper layer that lies at the origin of the degraded electrical characteristics of aluminum cables, in particular in terms of conductivity. Because of the intermediate layer interposed between the aluminum and the copper, the lifetime of the cable is lengthened.

Another advantage of the invention lies in the fact that the wires can be wire-drawn after the various layers have been deposited.

What is claimed is:

1. A method of fabricating a cable made up of an assembly of wires, each wire having a central conductor of aluminum covered in a layer of copper, said method serving to improve the mechanical characteristics of the cable, in particular in elongation and in bending, and also to increase its lifetime, said method comprising the steps of:
interposing an intermediate layer between said central conductor and said copper layer, said intermediate layer being made of a metal selected from nickel, niobium, tantalum, and vanadium.

2. A method according to claim 1, wherein said intermediate layer of nickel is deposited by electrolytic nickel plating.

3. A method according to claim 2, wherein the section of the intermediate layer of nickel of each wire lies in the range 0.01% to 5% of the total section of the wire.

4. A method according to claim 1, wherein the copper layer is deposited by electrolytic copper plating.

5. A method according to claim 4, wherein the section of the copper layer of each wire lies in the range 10% to 30% of the total section of the wire.

6. A method according to claim 1, wherein the intermediate layer of niobium, tantalum, or vanadium is made by wrapping niobium, tantalum, or vanadium strip around the aluminum central conductor.

7. A method according to claim 6, wherein the section of the intermediate layer of niobium, tantalum, or vanadium of each wire has a thickness lying in the range 0.01% to 5% of the total section of the wire.

8. A method according to claim 1, wherein said intermediate layer is deposited on an aluminum bar.

9. A method according to claim 8, wherein said aluminum bar covered in said intermediate layer is welded continuously, then cold-drawn, and then wire-drawn in order to said cable.

10. A method according to claim 8, wherein said aluminum bar covered in said intermediate layer is placed in a copper tube having an inside diameter slightly greater than the diameter of the aluminum bar.

11. A method according to claim 10, wherein the assembly constituted by the aluminum bar covered in said intermediate layer and placed in the copper tube is initially cold-drawn and then wire-drawn in order to obtain said cable.

12. A method according to claim 10, wherein the assembly formed by the aluminum bar covered in said intermediate layer and placed in the copper tube is initially cold-extruded or hot-extruded, and is then wire-drawn in order to obtain said cable.

13. A method according to claim 1, wherein an additional layer of nickel is deposited on said copper layer in order to prevent the copper from oxidizing.

14. An aluminum cable presenting mechanical characteristics, in particular in terms of elongation and bending, and a lifetime that are improved, the cable being fabricated using the method defined in claim 1.
